(19) United States
(12) Patent Application Publication
(10) Pub. No.: US 2007/0114783 A1
(43) Pub. Date: May 24, 2007

(54) Bound component with place holding cover

(76) Inventors: Amy Elizabeth Glosh, Kettering, OH (US); Jill Marie Broering, Troy, OH (US)

Correspondence Address: THOMPSON HINE L.L.P., P.O. BOX 8801, DAYTON, OH, 45401-8801, US

(21) Appl. No.: 11/286,606

(22) Filed: Nov. 23, 2005

(51) Int. Cl. B42D 3/00

(52) U.S. Cl. 281/29

(57) ABSTRACT

A bound component that includes a plurality of bound pages and a cover bound to the plurality of bound pages. The cover includes a flap which is insertable into the plurality of bound pages at various locations thereof to operate as a place holder. The bound component further includes a retaining mechanism configured to selectively circumscribe the plurality of bound pages to secure the bound component in a closed position.

### BACKGROUND

The present invention relates to a bound component, and more particularly, to a bound component having a flap for place marking pages of the bound component.

When the use of a bound component is interrupted (e.g., by phone call), or a user otherwise needs to mark a location in the bound component for future reference, a place marking device is typically used. The most common implementation of a place marker is to place a paper strip between selected pages of the bound component to function as a place marker. A problem with the use of the paper strip in this manner is that it does not readily remain within the bound component and is frequently lost or otherwise misplaced.

Accordingly, there is a need for a place marker that may be used for place marking selected pages of the bound component that is an integral part of the bound component.

### SUMMARY

In one embodiment the invention is a bound component that includes a plurality of bound pages and a cover bound to the plurality of bound pages. The cover includes a flap which is insertable into the plurality of bound pages at various locations thereof to operate as a place holder. The bound component further includes a retaining mechanism configured to selectively circumscribe the plurality of bound pages to secure the bound component in a closed position.

Other aspects of the invention will become apparent from the following description, the accompanying drawings and the appended claims.

### BRIEF DESCRIPTION OF THE DRAWINGS

FIG. 1 is a front perspective view of one embodiment of the bound component of the present invention, showing the flap wrapped around the front cover and the retaining mechanism in a non-use position;

FIG. 2 is a front perspective view of the bound component of FIG. 1, shown in its open position;

FIG. 3 is a front perspective view of the bound component of FIG. 2, showing the flap placed on or inserted into the plurality of bound pages;

FIG. 4 is a side view of the bound component of FIG. 3 moved to its closed position and with the retaining mechanism securing the bound component in the closed position;

FIG. 4B is a side view of one embodiment of the bound component of the present invention, showing the flap inserted into the plurality of bound pages, and the alternative retaining mechanism securing the bound component in the closed position;

FIG. 5 is a front perspective view of the bound component of FIG. 4;

FIG. 6 is a side view of the bound component of FIG. 1 with the retaining mechanism securing the bound component in the closed position;

FIG. 6B is a side view of the bound component of FIG. 4B showing the flap wrapped around the front cover, and the alternative retaining mechanism securing the bound component in the closed position;

FIG. 7 is a front perspective view of the bound component of FIG. 6;

FIG. 8 is a bottom perspective view of the bound component of FIG. 7; and

FIG. 8B is a bottom perspective view of the bound component of FIG. 6B.

### DETAILED DESCRIPTION

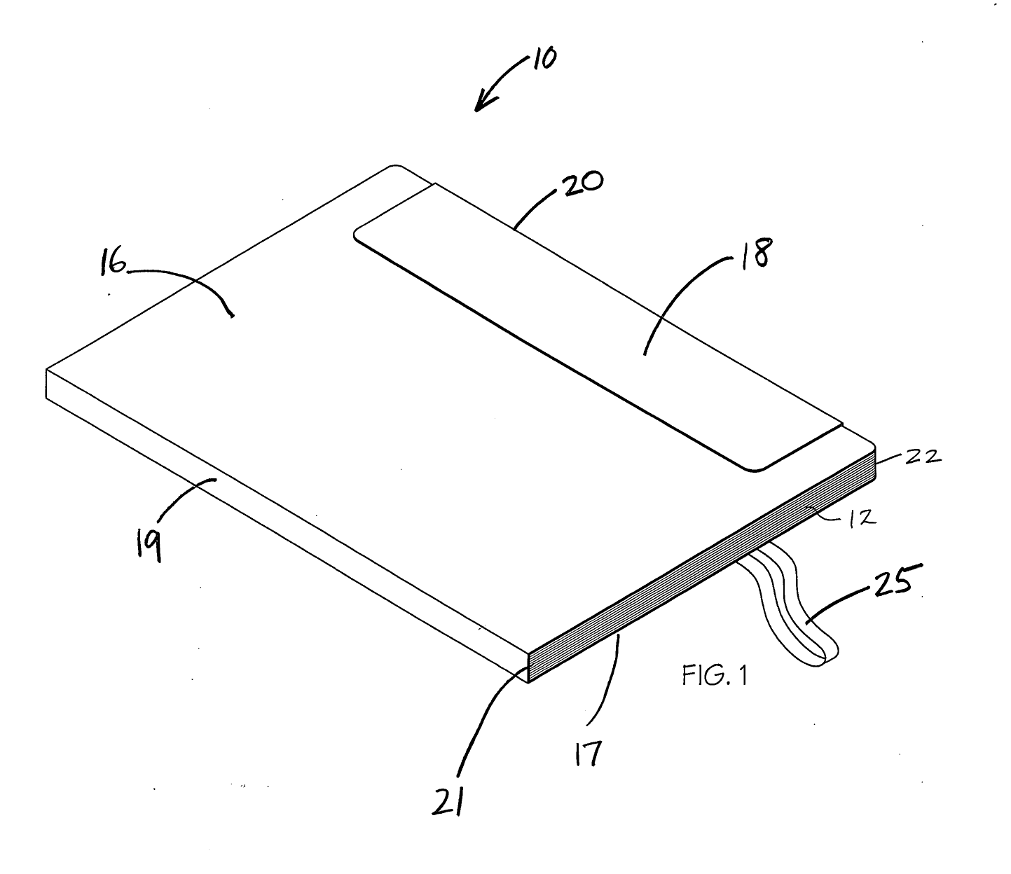

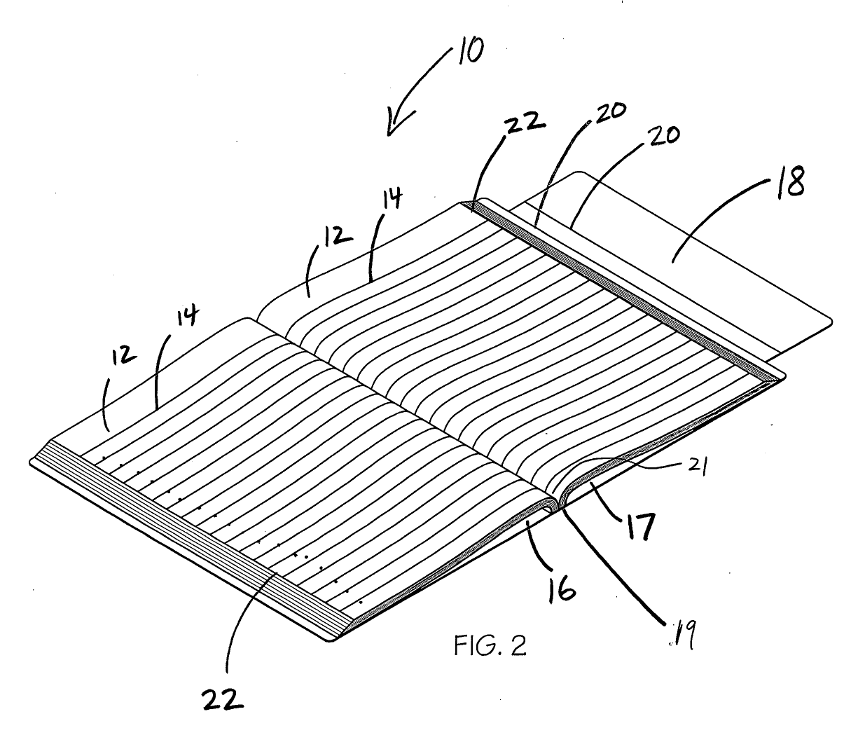

As shown in FIGS. 1-3, in one embodiment of the present invention, the bound component 10 includes a plurality of bound pages 12. In the illustrated embodiment, each bound page 12 may include a plurality of generally horizontally extending ruled guidelines 14 printed on both sides of each bound page 12 to guide writing on the bound component 10. However, the plurality of bound pages 12 can take any of a variety of writing guide formats, including but not limited to lined, blank, graph or any combinations thereof. Furthermore, the writing guide formats may be present on one or both sides of each bound page 12. Each bound page 12 may be made of a generally water absorbent material such as cellulose or pulp-based paper to allow a user to write information with a wide variety of writing instruments, including pen, pencil, marker and the like.

The bound component 10 may further include a front cover 16 and a back cover 17. Each cover 16, 17 can have a stiffness or thickness greater than each of the bound pages 12 to provide protection to the pages 12. For example, the covers 16, 17 can be made of cardboard, plastic, tweeds, faux leathers, cottons, silks and the like, and may have generally the same size and shape as the bound pages 12. The bound component 10 further includes a binding mechanism 19 binding the front and back covers 16, 17 and the bound pages 12 together. Each bound page 12 includes a binding edge 21 adjacent to the binding mechanism 19 and a free edge 22 on a generally opposite side thereof. In the illustrated embodiment, the binding mechanism 19 is an adhesive binding mechanism. However, the binding mechanism 19 can take any of a variety of forms, including but not limited to coil binding mechanisms, spiral binding mechanisms, three-ring binders, prong binding mechanisms, case binding mechanisms, perfect binding mechanisms, stitched binding mechanisms, etc.

The back cover 17 includes a outwardly extending generally flat, planar flap 18 which may be integrally formed with the main body of the back cover 17. The flap 18 can extend from a longitudinal edge of the back cover 17. Rather than being located on the back cover 17, the flap 18 could instead or in addition be located on the front cover 16. The flap 18 can have the same stiffness or thickness as the back cover 17, and be made of cardboard, plastic, tweeds, faux leathers, cottons, silks and the like. If desired, the flap 18 could also be a separate piece of material coupled to the body of the back cover 17. The flap 18 may include a plurality of folding lines 20 extending generally parallel to the longitudinal edge of the bound component 10 and parallel to the free edges 22 of the bound component pages 12.

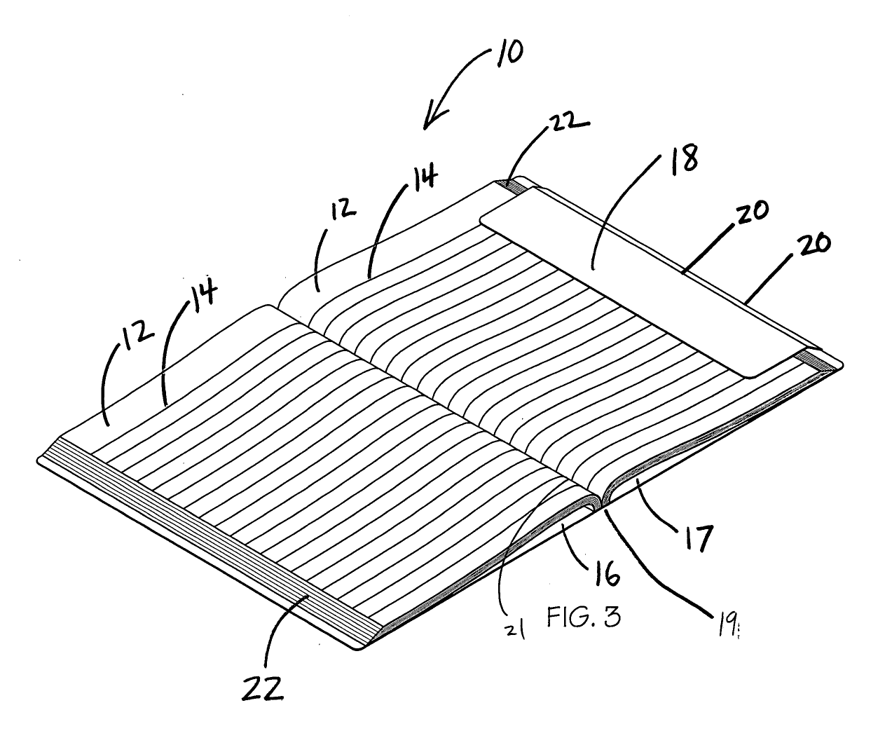

As shown in FIGS. 3-5, the flap 18 can be folded and bent along the folding lines 20 and inserted into the pages 12 of the bound component 10 for a convenient marking purpose. The flap 18 may have a length that is at least about 50% of the length of the free edge 22 of each page 12 to provide a flap 18 which can be easily handled and located. The folding lines 20 of the flap 18 allow easy bending or folding of the flap 18 to be inserted between two adjacent bound pages 12 of the bound component 10. The flap 18 may be configured such that when the flap 18 is inserted between the free edge 22 of two adjacent bound pages 12 of the bound component 10 the flap 18 is inserted to a depth of less than about 25% of the width of each of said bound pages 12. This allows the flap 18 to be easily inserted into and removed from the bound pages 12. As shown in FIG. 1, the foldable flap 18 may be folded and bent along the folding lines 20 and wrapped around the front cover 16.

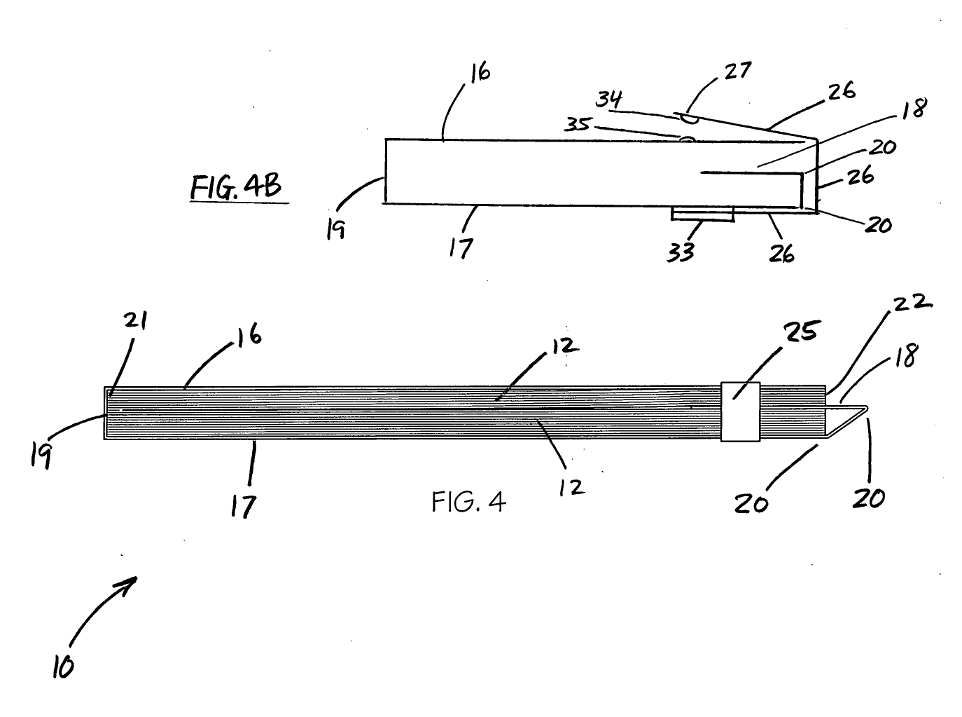

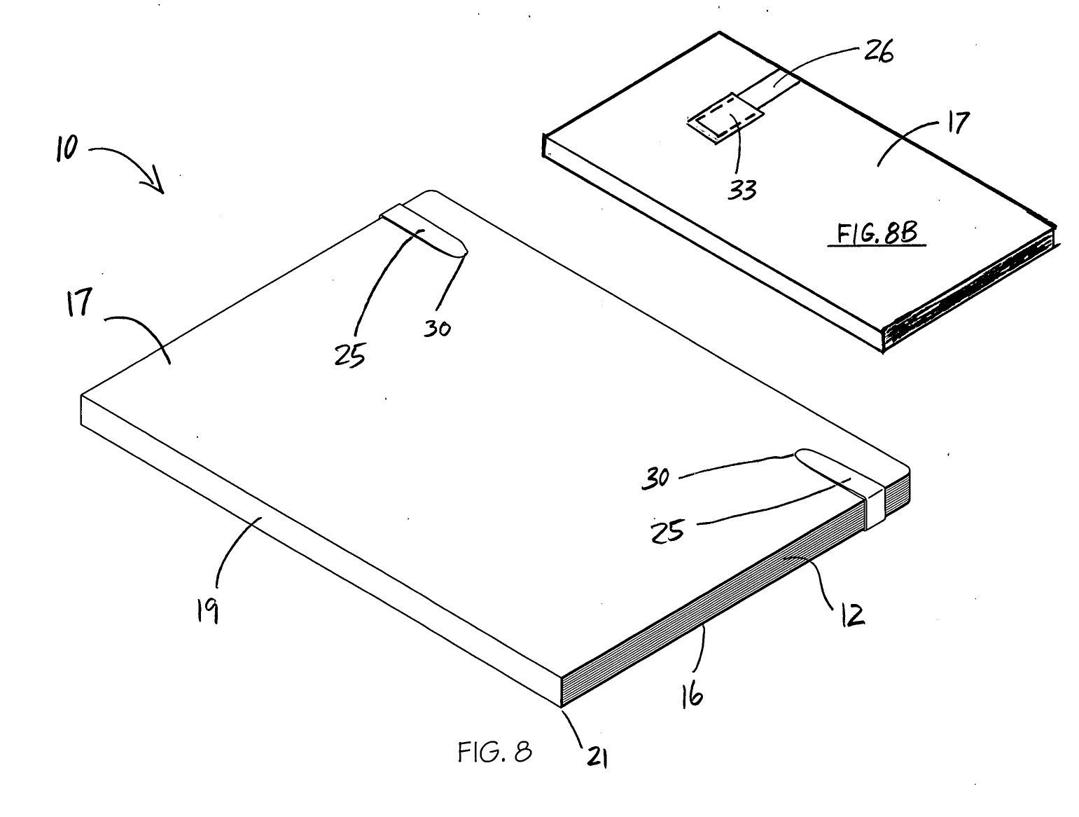

The bound component 10 further includes a retaining mechanism 25 configured to selectively circumscribe the bound component 10 (i.e., the front and back covers 16, 17 and the plurality of bound pages 12) to secure the bound component 10 in a closed position, for example as shown in FIG. 4. In one embodiment of this invention, the retaining mechanism 25 is an elastic strap 25 which can be expanded and passed around the front 16 and back 17 covers and bound pages 12 to secure the bound component 10 in its closed position. The elastic strap 25 may be made of a generally stretchable solid material which may be extended when stretching forces are applied, and will sustain this extended shape while securing the bound component 10 in its closed position, but will recover its original shape when the stretching forces are removed. The elastic strap 25 can be made of materials such as natural rubber, synthetic rubber, elastomeric plastic, elastomeric woven or braided fabric containing elastic fibers or the like. The retaining mechanism 25 may be coupled to the back cover 17 at a pair of connection points 30, as shown in FIG. 8. The retaining mechanism 25 may be located adjacent to a free edge of the back cover 17.

In one embodiment of the invention, the elastic strap 25 may be secured to the back cover 17, although the elastic strap 25 may be secured to other locations of the bound component 10, such as but not limited to, the front cover 16. Securing the elastic strap 25 by a pair of connection points 30 ensures that the retaining mechanism 25 is not lost or misplaced. The elastic strap 25 may be connected to the front 16 or back cover 17 by stitching, hook-and-loop fastening material (such as VELCRO®), buttons, or similar fasteners.

In order to utilize the bound component 10, a user may first write or read information on the bound pages 12 in the standard manner. When the user desires to place mark the bound component 10 for future reference, as shown in FIGS. 3-5, the foldable flap 18 can be folded and bent along the folding lines 20 and inserted between two adjacent bound pages 12 of the bound component 10 through the free edge 22 of each bound page 12. The bound component 10 can then be closed while the flap 18 remains inserted in the bound pages 12. The elastic strap 25 can be then expanded and passed around the front 16 and back 17 covers to secure the bound component 10 in its closed position.

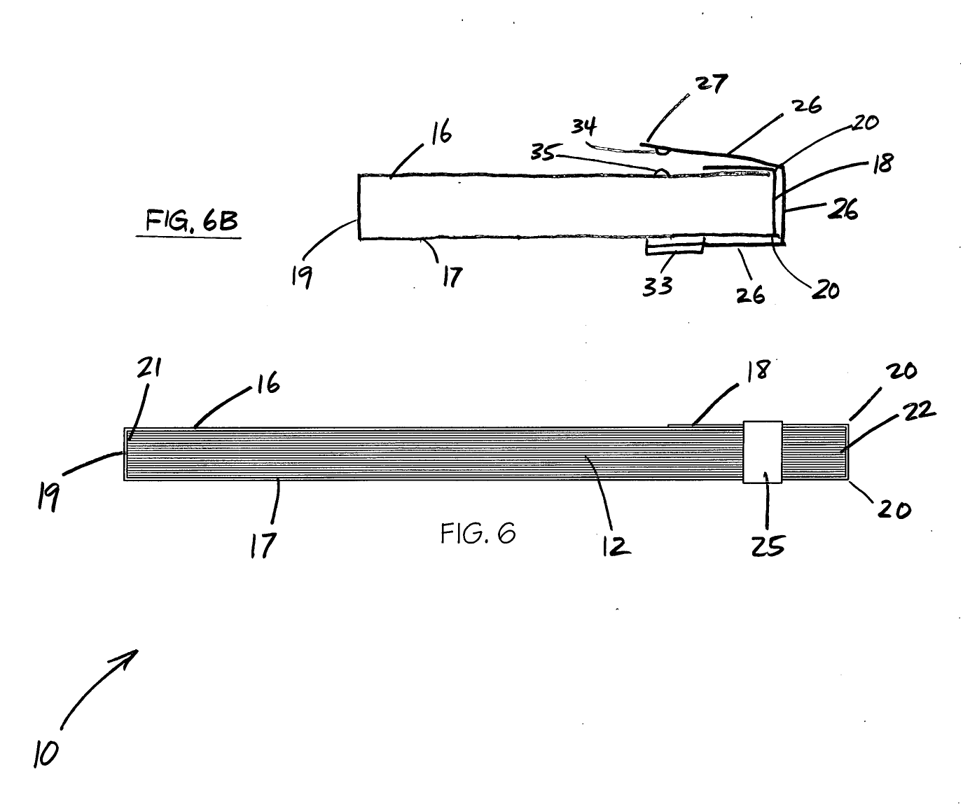

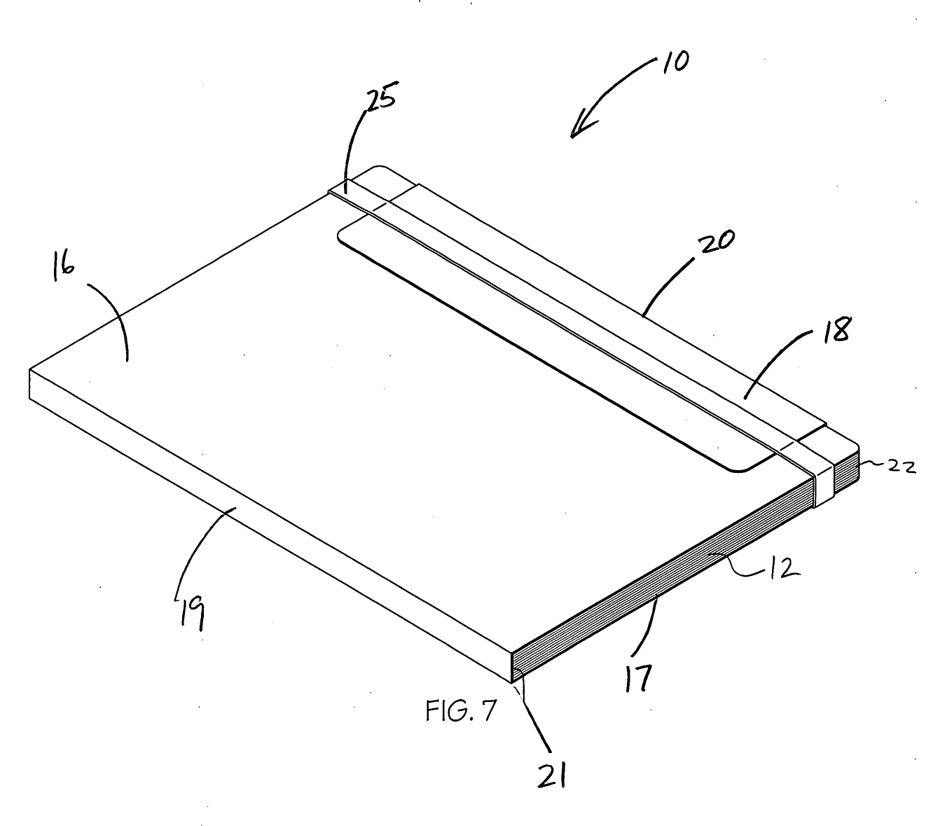

Furthermore, as shown in FIGS. 6-7, the bound component 10 can be closed and the foldable flap 18 can be folded and bent along the folding lines 20 and wrapped around the front cover 16. The elastic strap 25 can then be expanded and passed around the flap 18 and back cover 17 to secure the bound component 10 in its closed position. This configuration may be used when there are no pages 12 to be marked, or when it is desired to protect the free edge 22 of each page 12.

In the configuration shown in FIG. 4, the bound component 10 may have the flap 18 inserted into the plurality of bound pages 12 and the elastic strap 25 secures the bound component 10 in a closed position.

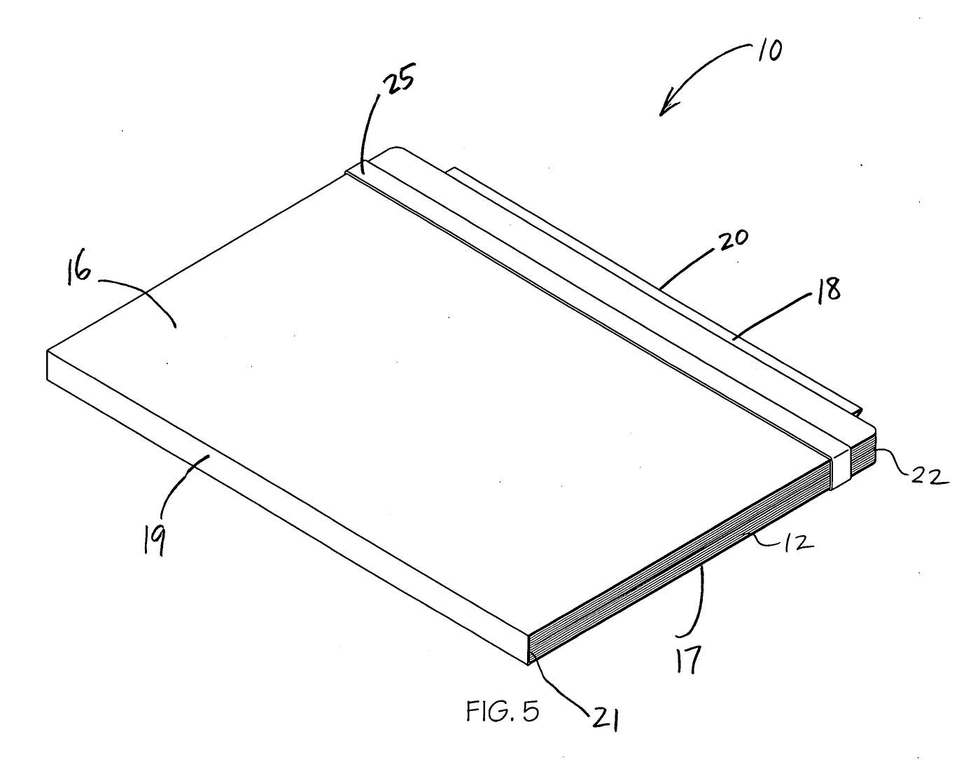

As shown in FIG. 3, the flap 18 can be utilized as a place holder in that the flap 18 can be inserted at any location in the depth of the bound pages 12 to mark a place. As shown in FIG. 5, when the flap 18 is used in this manner, the elastic strap 25 can be fit over the covers 16, 17 to retain the flap 18 in place and keep the bound component 10 closed.

As shown in FIGS. 4-5, the elastic strap 25 is positioned to the outer edge of the bound component 10, and the flap 18 is inserted to a sufficient depth such that the flap 18 is located below the elastic strap 25. In other words, the flap 18 is generally encircled by the elastic strap 25. This arrangement ensures that the bound pages 12 are tightly pressed against the flap 18 to frictionally grip the flap 18 in place. Furthermore, as shown in FIGS. 6-7, when the flap 18 is located on the front cover 16, the elastic strap 25 is located directly on top of the flap 18. This direct engagement ensures that the elastic strap 25 holds the flap 18 securely in place. However, the use of a circumscribing strap, in general, helps to frictionally grip the flap 18 and hold the flap 18 in place.

In accordance with an embodiment of this invention, the elastic strap 25 is incorporated into the bound component 10 to allow single hand operation of the elastic strap 25. A method for manipulating the bound component 10 may include the steps of: (i) inserting the flap 18 between desired pages 12 using one hand, and (ii) circumscribing the front 16 and back 17 covers with the elastic strap 25 using the same hand.

In one embodiment of the present invention, as shown in FIGS. 4B, 6B and 8B, an alternative retaining mechanism 26 may be configured to wrap around a portion of the bound component 10 to secure the bound component 10 in a closed position. The alternative retaining mechanism 26 can include either a non-extensible or an extensible fabric strap 26 which may be attached to the back cover 17 at a connection point 33 and the strap free end 27 is secured to the front cover 16 by a hook and loop fastening material 34, 35 (such as VELCRO®) in the standard manner. Other releasable fastening means for the strap free end 27 and the front cover 16 include, but are not limited to, mechanical snaps, magnets, releasable adhesive, buttons and ribbons. As illustrated in FIGS. 4B and 6B, a material such as VELCRO® may be attached to the underside of the strap free end at position 34 and onto the front cover at position 35 in such a manner that positions 34 and 35 will significantly overlap when the strap free end 27 is pulled towards the front cover 16. The strap 26 can be made of non-extensible materials such as woven or braided nylon, cotton, polyester or the like.

When the user desires to place mark the bound component 10 for future reference, as shown in FIG. 4B, the foldable flap 18 can be folded and bent along the folding lines 20 and inserted between two adjacent bound pages 12 of the bound component 10 through the free edge 22 of each bound page 12. The bound component 10 can then be closed while the flap 18 remains inserted in the bound pages 12. The retaining mechanism 26 may be wrapped around the free edges 22 of the bound pages 12 and the flap 18 while pulling the strap free end 27 towards the front cover 16 to secure the bound component 10 in its closed position. The bound component 10 is re-opened by pulling the strap free end 27 away from the front cover 16 to separate the VELCRO® material at positions 34, 35.

Furthermore, as shown in FIG. 6B, the bound component 10 can be closed and the foldable flap 18 can be folded and bent along the folding lines 20 and wrapped around the front cover 16. The alternative retaining mechanism 26 may be wrapped around the free edges 22 of the bound pages 12 and the flap 18 while pulling the strap free end 27 towards the front cover 16 to secure the bound component 10 in its closed position. The alternative retaining mechanism 26 protects the free edges 22 of the bound pages 12 in the configuration when there are no pages 12 to be marked and in the configuration when the user desires to place mark adjacent pages 12 using the flap 18.

As shown in FIG. 8B, securing the strap 26 at the connection point 33 on the back cover 17 ensures that the alternative retaining mechanism 26 is not lost or misplaced. As illustrated the strap 26 is connected to the back cover 17 by stitching. However, other permanent fastening means for the strap 26 and back cover 17 include, but are not limited by, permanent adhesive or permanent mechanical fixtures.

Although the invention is shown and described with respect to certain aspects, modifications may occur to those skilled in the art upon reading the specification. The bound component with place holding cover includes all such modifications and is limited only by the scope of the claims.

What is claimed is:

1. A bound component comprising:
a plurality of bound pages;
a cover bound to said plurality of bound pages, said cover including a flap which is insertable into said plurality of bound pages at various locations thereof to operate as a place holder; and
a retaining mechanism configured to selectively circumscribe said plurality of bound pages to secure said bound component in a closed position.

2. The component of claim 1 wherein each of said bound pages are bound at or adjacent to a binding edge and have a free edge on a generally opposite side thereof, wherein said flap is configured to be inserted between the free edge of two adjacent ones of said bound pages.

3. The component of claim 2 wherein said retaining mechanism is configured to circumscribe said plurality of bound pages adjacent to said free edges thereof.

4. The component of claim 2 wherein said flap has a length that is at least about 50% of the length of said free edge of each page.

5. The component of claim 2 wherein said flap is configured such that when said flap is inserted between the binding edge of two adjacent ones of said bound pages said flap is inserted to a depth of less than about 25% of the width of each of said bound pages.

6. The component of claim 1 wherein said cover is bound to said pages about a binding edge and has a free edge on a generally opposite side thereof, and wherein said flap is coupled to said cover adjacent to said free edge.

7. The component of claim 1 wherein said cover has at least one of a thickness or stiffness greater than each of said pages.

8. The component of claim 1 wherein said cover has about the same size and shape as each of said pages.

9. The component of claim 1 further comprising a supplemental cover located on an opposite side of said plurality of bound pages relative to said cover, and wherein said flap is movable to a cover position wherein said flap is located on top of said supplemental cover.

10. The component of claim 9 wherein said retaining mechanism is configured to be located on or adjacent to said flap when said flap is in said cover position and said retaining mechanism circumscribes said component.

11. The component of claim 1 wherein said retaining mechanism is made of an elastic material.

12. The component of claim 1 wherein said flap is integrally formed with said cover as a single piece of material.

13. The component of claim 12 wherein said cover is bound to said pages about a binding edge and has a free edge on a generally opposite side thereof, and wherein said flap has a pair of fold lines extending generally parallel to said free edge to allow said flap to be folded over said plurality of pages.

14. The component of claim 1 wherein said flap is insertable into said plurality of bound pages to a sufficient depth such that when said retaining mechanism selectively circumscribes said plurality of bound pages said retaining mechanism is located immediately above at least part of said inserted flap.

15. A method for manipulating a bound component comprising the steps of:
providing a bound component having a plurality of bound pages, a cover bound to said plurality of bound pages, said cover including a flap, said bound component further including a retaining mechanism;
inserting said flap between two adjacent bound pages of said plurality of bound pages to operate as a place holder; and
circumscribing said retaining mechanism about said plurality of bound pages to secure said bound component in a closed position.

16. A bound component comprising a front cover, a back cover, a spine, a plurality of bound pages interposed between said covers, and a retaining means adapted to selectively circumscribe the front and back covers along a direction parallel to said spine for securing the bound component in a closed position, the bound component further comprising an outwardly extending flap integrally formed on a free edge of the front or back cover for place marking of selected bound pages.

17. The component of claim 16 wherein the outwardly extending flap is directly coupled to said back cover and is configured to be at least partially wrapped around the front cover and held in place by said retaining means.

18. A method for manipulating a bound component comprising the steps of:
providing a bound component having a plurality of bound pages, a cover bound to said plurality of bound pages, said cover including a flap, said bound component further including a retaining mechanism;
manually inserting said flap into said plurality of bound pages to operate as a place holder; and
manually positioning said retaining mechanism about said plurality of bound pages such that said retaining mechanism circumscribes said plurality of bound pages to secure said bound component in a closed position.

19. A bound component comprising:
a plurality of bound pages;
a front and back cover bound to said plurality of bound pages, said back cover including a flap which is insertable into said plurality of bound pages at various locations thereof to operate as a place holder; and
a retaining mechanism comprising a strap wherein said strap is permanently coupled to one of said front or back covers and is releasably attachable to other one of said front or back covers to secure said bound component in a closed position.

20. The component of claim 19 wherein said front cover further comprises a binding edge and a free edge, said strap further comprises a permanently coupled end and a free end, said strap free end releasably attached to one of said front or back covers, said strap on top of said free edge of said front cover to secure said bound component in a closed position.

21. The component of claim 20 wherein said flap is movable to a cover position wherein said flap is located on top of one of said front or back covers, wherein said strap free end is releasably attachable to other one of said front or back covers to secure said bound component in a closed position.
